(19) United States
(12) Patent Application Publication
(10) Pub. No.: US 2017/0133661 A1
(43) Pub. Date: May 11, 2017

(54) HIGH ENERGY CATHODE MATERIAL

(71) Applicant: Wildcat Discovery Technologies, Inc., San Diego, CA (US)

(72) Inventors: Marissa Caldwell, San Diego, CA (US); Jen-Hsien Yang, San Diego, CA (US); Bin Li, San Diego, CA (US)

(73) Assignees: Wildcat Discovery Technologies, Inc., San Diego, CA (US); Tianjin B&M Science and Technology Joint-Stock Co., Ltd., Tianjin (CN)

(21) Appl. No.: 14/936,144

(22) Filed: Nov. 9, 2015

(51) Int. Cl. H01M 4/04; H01M 4/52; H01M 4/505

(52) U.S. Cl. CPC H01M 4/0471; H01M 4/505; H01M 4/523; H01M 4/04; H01M 10/0525

(57) ABSTRACT

A method for synthesizing high voltage active materials using a process control agent. The process control agent may be a carbon source. The active material may be a spinel.

### BACKGROUND OF THE INVENTION

The present invention is in the field of battery technology and, more particularly, in the area of high-energy materials for use in electrodes in electrochemical cells.

Cathodes formed from active materials of the composition LiM₂O₄ are a common class of active materials in lithium ion batteries, where M includes a transition metal. The LiM₂O₄ active material can have a spinel structure. Transition metals such as manganese have been used as the transition metal in LiM₂O₄ active materials and, in some instances, both manganese and nickel have been used.

LiMn₂O₄ has been widely used in commercial batteries, and LiMn_{1.5}Ni_{0.5}O₄ (LMNO) is an excellent candidate to replace LiMn₂O₄ because LMNO has about a 30% energy density improvement as compared to LiMn₂O₄. This energy density improvement is due to the higher voltage potential (4.7 V) and the higher capacity of the LMNO materials as compared to LiMn₂O₄. For the sake of comparison, a LiMn₂O₄ active material has a theoretical gravimetric energy density of about 492 Wh/kg and a LiMn_{1.5}Ni_{0.5}O₄ has a theoretical gravimetric energy density of about 691 Wh/kg.

Further, LMNO materials used in lithium ion batteries have demonstrated substantial rate capability, such as a rate capability of greater than 120 mAh/g at a 20 C rate. However, the state-of-the-art LMNO that demonstrates this high rate capability still shows relatively poor cycle life (that is, the capacity retention diminishes substantially with increasing cycles). The poor cycle life limits the operation of batteries containing LMNO active materials when they are used at high voltages and/or at high temperatures.

The challenges of limited cycle life in LiM₂O₄ active materials can be addressed by certain embodiments of the invention described herein.

### BRIEF SUMMARY OF THE INVENTION

Embodiments of the invention include a method for producing an active material for use in a lithium ion battery. The method can include providing a lithium precursor, a transition metal precursor, and a process control agent. The method can further include milling the lithium precursor, the transition metal precursor, and the process control agent to form a milled powder. The method can further include heating the milled powder for a time and temperature to form the active material.

In some embodiments, the process control agent includes a carbon source. In some embodiments, the carbon source includes carbon black. In some embodiments, the carbon source includes graphite. In some embodiments, the carbon source includes an ethylene oxide polymer. In some embodiments, the carbon source includes poly(ethylene oxide).

In some embodiments, the milled powder contains unreacted process control agent. In some embodiments, the heating consumes substantially all of the unreacted process control agent.

In some embodiments, the transition metal precursor includes manganese. In some embodiments, there is an additional transition metal precursor. In some embodiments, the additional transition metal precursor includes nickel. In some embodiments, the active material includes LiMn_{1.5}N_{10.5}O₄.

Embodiments of the invention include batteries having an electrode formed from any of the active materials disclosed above.

Embodiments of the invention include processes for making the active materials disclosed above as described herein.

### BRIEF DESCRIPTION OF SEVERAL VIEWS OF THE DRAWINGS

FIG. 1 is a scanning electron micrograph of an LMNO active material synthesized with conductive carbon as a process control agent according to an embodiment of the invention.

FIG. 2 is a scanning electron micrograph of an LMNO active material synthesized without a process control agent according to conventional methods.

FIG. 3A illustrates the results of electrochemical testing of batteries formed using certain embodiments of the invention as compared to a control material. In this case, the capacity of the inventive material is improved as compared to the control material.

FIG. 3B illustrates the results of electrochemical testing of batteries formed using certain embodiments of the invention as compared to a control material. In this case, the capacity retention of the inventive material is improved as compared to the control material.

FIG. 4A illustrates the results of electrochemical testing of the capacity of batteries formed using various embodiments of the invention as compared to a control material.

FIG. 4B illustrates the results of electrochemical testing of the capacity retention of batteries formed using various embodiments of the invention as compared to a control material.

### DETAILED DESCRIPTION OF THE INVENTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

The terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “transition metal” refers to a chemical element in groups 3 through 12 of the periodic table, including scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs), and meitnerium (Mt).

The term “spinel” refers to the metal oxide material with a spinel structure generally understood to be useful for electrode materials in lithium ion batteries.

The term “specific capacity” refers to the amount (e.g., total or maximum amount) of electrons or lithium ions a material is able to hold (or discharge) per unit mass and can be expressed in units of mAh/g. In certain aspects and embodiments, specific capacity can be measured in a constant current discharge (or charge) analysis, which includes discharge (or charge) at a defined rate over a defined voltage range against a defined counter electrode. For example, specific capacity can be measured upon discharge at a rate of about 0.05 C (e.g., about 7 mA/g) from 4.95 V to 3.0 V versus a Li/Li+ counter electrode. Other discharge rates and other voltage ranges also can be used, such as a rate of about 0.1 C (e.g., about 14 mA/g), or about 0.5 C (e.g., about 70 mA/g), or about 1.0 C (e.g., about 140 mA/g).

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

To the extent certain battery characteristics can vary with temperature, such characteristics are specified at 30 degrees C., unless the context clearly dictates otherwise.

Ranges presented herein are inclusive of their endpoints. Thus, for example, the range 1 to 3 includes the values 1 and 3 as well as the intermediate values.

Embodiments of the present invention provide novel materials for use as active materials in cathodes of an electrochemical cell. The materials of the present invention address the challenges described above for existing cathode active materials.

Specifically, embodiments disclosed herein use a new synthesis method for producing active materials for lithium ion batteries. In some cases, the active materials are spinel active materials. In other cases, other active materials can be produced with the synthetic method disclosed herein, include oxides and phosphates.

A notable feature of the embodiments disclosed herein is the use of an additive during the synthesis process. The additive can be referred to as a process control agent, as it affects the synthesis process to produce an active material with substantially improved performance. A significant feature of certain of the process control agents disclosed herein is that there is almost no residual material from the process control agents in the final synthesized material. Because there is almost no residual material from the process control agents, no additional purification steps are required. In preferred embodiments, the process control agent is a carbon source included with the active material precursors during the active material synthesis.

As discussed in further detail below, the synthesis of the active materials involves a milling process, where precursors of the components of the active material are combined and reacted. A calcination process is used to further react the precursor materials and produce the final active material. The introduction of a process control agent during the milling and/or calcination can facilitate the production of active materials with improved performance. In particular, spinel active materials benefit from the use of a process control agent.

Preferred process control agents include those capable of providing sacrificial carbon during the milling and calcination process of synthesizing active materials. For example, carbon sources such as carbon black (e.g., SuperP from TIMCAL), graphite, polymers and/or oligomers containing ethylene oxide. For comparison, carbon black has a relatively larger surface area than graphite (˜20 m²/g). If measured by BET analysis (as described below, the BET of carbon black is typically about 60 m²/g and the BET of graphite is typically about 20 m²/g.

Without being bound to any theory or mechanism of action not recited in the claims, the addition of a process control agent can alter the synthesis of an active material in a few ways. In the case of spinel synthesis, which includes a mixing step and a calcination step, the addition of a process control agent can alter the synthesis. In the mixing step (and specifically when the mixing step is a milling step), the process control agent acts as an interface between milling balls (in the case of a balling milling apparatus) and the active materials to reduce the milling energy imparted to the active material precursors. During the milling process, the process control agent can form a kind of coating, layer, or buffer on the active material surface, which reduces the agglomeration of the active materials. So, the process control agent can also affect the particle size yielded by the milling process as well as the particle growth during the calcination process. Further, the process control agent can alter the surface morphology and/or surface chemistry of the particles of active material that emerge from the milling process.

In the calcination process, the particle size, surface morphology, and surface chemistry are all relevant factors that influence the reactivity of the milled mixture. Thus, the process control agent can influence the calcination process simply by altering the yield of the milling process. Alternately or additionally, the process control agent can affect the atmosphere of the calcination process as it is consumed. For example, a carbon source used as a process control agent can provide a reductive environment (as opposed to a neutral or oxidative environment). The presence of the process control during calcination may also alter the rate of particle sintering and/or particle growth. The presence of the process control during calcination may help reduce the amount of surface defects in the final particles of active material.

In preferred embodiments, the process control agent is substantially, almost completely, or completely consumed during the active material synthesis process. In the case of a carbon source process control agent, the process control agent that is unreacted during the milling step may react during the calcination step. Residual process control agent may burn off during the high temperature calcination.

Thus, the process control agents of embodiments disclosed herein not only change the synthesis process, which changes the final product physical properties and the electrochemical performance, but also do not leave substantial residuals from the process control in the final product.

In certain embodiments, the process control agent is added to the precursor mixture prior to milling in an amount of at least 0.5% by weight, at least 1.0% by weight, at least 1.5% by weight, at least 2.0% by weight, at least 2.5% by weight, at least 3.0% by weight, at least 3.5% by weight, at least 4.0% by weight, at least 4.5% by weight, at least 5.0% by weight, at least 5.5% by weight, at least 6.0% by weight, at least 6.5% by weight, at least 7.0% by weight, at least 7.5% by weight, at least 8.0% by weight, at least 8.5% by weight, at least 9.0% by weight, at least 9.5% by weight, at least 10.0% by weight, or at least 10.5% by weight of the total weight of the mixture.

In certain embodiments, powder resulting from the milling process was calcined at a temperature greater than about 650 degrees C., greater than about 660 degrees C., greater than about 670 degrees C., greater than about 680 degrees C., greater than about 690 degrees C., greater than about 700 degrees C., greater than about 710 degrees C., greater than about 720 degrees C., greater than about 730 degrees C., or greater than about 740 degrees C., greater than about 750 degrees C., greater than about 760 degrees C., greater than about 770 degrees C., greater than about 780 degrees C., greater than about 790 degrees C., greater than about 800 degrees C., greater than about 810 degrees C., greater than about 820 degrees C., greater than about 830 degrees C., or greater than about 840 degrees C., greater than about 850 degrees C., greater than about 860 degrees C., greater than about 870 degrees C., greater than about 880 degrees C., greater than about 890 degrees C., greater than about 900 degrees C., greater than about 910 degrees C., greater than about 920 degrees C., greater than about 930 degrees C., or greater than about 940 degrees C., or greater than about 950 degrees C.

In certain embodiments, powder resulting from the milling process was calcined at a temperature less than about 950 degrees C., less than about 940 degrees C., less than about 930 degrees C., less than about 920 degrees C., less than about 910 degrees C., less than about 900 degrees C., less than about 890 degrees C., less than about 880 degrees C., less than about 870 degrees C., less than about 860 degrees C., less than about 850 degrees C., less than about 840 degrees C., less than about 830 degrees C., less than about 820 degrees C., less than about 810 degrees C., less than about 800 degrees C., less than about 790 degrees C., less than about 780 degrees C., less than about 770 degrees C., less than about 760 degrees C., less than about 750 degrees C., less than about 740 degrees C., less than about 730 degrees C., less than about 720 degrees C., less than about 710 degrees C., less than about 700 degrees C., less than about 690 degrees C., less than about 680 degrees C., less than about 670 degrees C., less than about 660 degrees C., or less than about 650 degrees C.

In certain embodiments, the calcination is performed for a time greater than about 0.1 hour, greater than about 0.5 hour, greater than about 1.0 hour, greater than about 1.5 hours, greater than about 2.0 hours, greater than about 2.5 hours, greater than about 3.0 hours, greater than about 3.5 hours, greater than about 4.0 hours, greater than about 4.5 hours, greater than about 5.0 hours, greater than about 5.5 hours, greater than about 6.0 hours, greater than about 6.5 hours, greater than about 7.0 hours, greater than about 7.5 hours, greater than about 8.0 hours, greater than about 8.5 hours, greater than about 9.0 hours, greater than about 9.5 hours, greater than about 10.0 hours, greater than about 10.5 hours, greater than about 11.0 hours, greater than about 11.5 hours, greater than about 12.0 hours, or greater than about 12.5 hours.

In certain embodiments, the calcination is performed for a time less than about 12.5 hours, less than about 12.0 hours, less than about 11.5 hours, less than about 11.0 hours, less than about 10.5 hours, less than about 10 hours, less than about 9.5 hours, less than about 9.0 hours, less than about 8.5 hours, less than about 8.0 hours, less than about 7.5 hours, less than about 7.0 hours, less than about 6.5 hours, less than about 6.0 hours, less than about 5.5 hours, less than about 5.0 hours, less than about 4.5 hours, less than about 4.0 hours, less than about 3.5 hours, less than about 3.0 hours, less than about 2.5 hours, less than about 2.0 hours, less than about 1.5 hours, less than about 1.0 hour, or less than about 0.5 hour.

The following examples describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### EXAMPLES

Synthesis. Spinel materials were synthesized by a milling and calcination process. Typically, stoichiometric amount of precursors for the lithium, manganese, and nickel content of the final material were milled. Suitable precursors include, but are not limited to, Li₂CO₃, Mn₂O₃, and Ni(OH)₂. Other precursors capable to donating lithium and the desired transition metals may be used. In embodiments including a process control agent, the process control agent was added to the precursor mixture prior to milling in an amount from about 1% by weight to about 10% by weight of the total weight of the mixture. The powder resulting from the milling process was calcined at a temperature range from about 700 degrees Celsius to about 900 degrees Celsius. Calcination times varied from about 0.5 hours to about 12 hours under optional air flow (about 20 L/min)

Battery Cell Formation. Battery cells were formed in a high purity argon filled glove box (M-Braun, O₂ and humidity content <0.1 ppm). The electrodes were prepared by following method. For the cathode, a spinel was mixed with poly(vinylidene fluoride) (Sigma Aldrich), carbon black (Super P Li, TIMCAL), using 1-methyl-2-pyrrolidinone (Sigma Aldrich) as solvent, and the resulting slurry was deposited on an stainless steel current collector and dried to form a composite cathode film. For the anode, a thin Li foil is cut into required size and used as anode. Each battery cell including the composite cathode film, a polypropylene separator, and lithium foil anode was assembled in a CR2032 coin cell (Hohsen). A conventional electrolyte mixed with an additive was used.

Testing. The battery cell was sealed and cycled between 3 V to 4.9 V at room temperature for an initial 4 cycles at a rate of 0.1 C rate. Later cycles were at elevated temperature (about 50 degrees Celsius) at a rate of 1 C.

### RESULTS

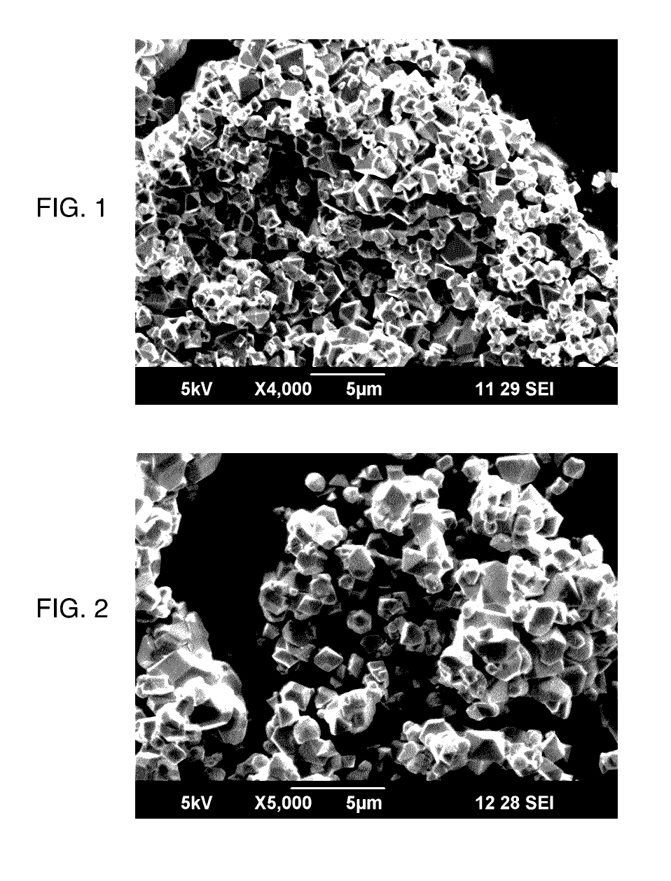

FIG. 1 is a scanning electron micrograph of an LMNO active material synthesized according to an embodiment of the invention with 5.0 weight percent carbon black. Presented for the sake of comparison, FIG. 2 is a scanning electron micrograph of an LMNO active material synthesized according to conventional methods.

The LMNO active materials depicted in FIGS. 1 and 2 were synthesized according to the methods described herein. The powder resulting from the milling process was calcined at a temperature of about 900 degrees Celsius for about 0.5 hours under optional air flow (about 20 L/min), which are preferred conditions for certain embodiments of the invention.

The micrographs in FIGS. 1 and 2 enable a qualitative comparison of the particle size and morphology of the LMNO active material synthesized with and without a process control agent, respectively. Generally speaking, the particles of the LMNO active material synthesized with a process control agent are smaller and more uniform (that is, the range of particle shapes is less varied) than the particles of the LMNO active material synthesized without a process control agent. Further, the surface properties (e.g., physical defects and/or physiochemical properties) of those two materials are different.

The differences between the particles of LMNO active material synthesized with and without a process control agent can be quantified using Brunauer-Emmett-Teller (BET) surface area analysis. BET analysis provides specific surface area evaluation of materials by gas adsorption measured as a function of relative pressure.

The measured BET surface area for the LMNO synthesized with a process control agent was 7.5 m²/g, while the BET surface area for the LMNO synthesized without a process control agent was 0.8 m²/g. The addition of the process control agent during synthesis yielded an almost ten-fold increase in surface area for the LMNO active material. Since there is almost no residue left from the process control agent in the final materials and the particle size change is relatively small, this substantial increase in surface area is unexpected based on prior known use of process control agents.

Without being bound to a particular theory or mechanism of action not recited in the claims, it is hypothesized that the increased surface area and/or the more regular shape of the active material particles will contribute to substantial improvements in the electrochemical performance of batteries including cathodes formed from active materials synthesized using a process control agent. The effect of the process control agent on the performance of batteries including cathodes formed from active materials synthesized using a process control agent is demonstrated in the following figures.

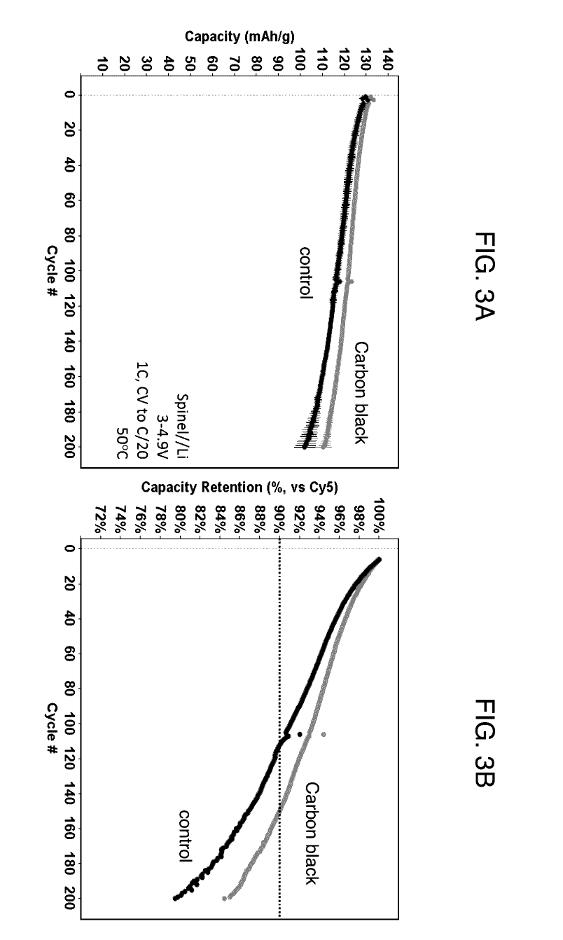

FIGS. 3A and 3B illustrate the results of electrochemical testing of batteries formed using certain embodiments of the invention as compared to a control material. The LMNO active material synthesized using a process control agent is labeled in FIG. 3A and FIG. 3B as “SuperP” and the LMNO active material synthesized without using a process control agent is labeled as “Control.” The battery cell was formed according to the methods disclosed herein, including the use of the lithium anode. After the formation cycles, the cell was cycled 200 times from about 3 V to about 4.9 V at an ambient temperature of about 50 degrees Celsius. These high voltage and high temperature conditions are challenging for conventional spinel active materials. The cycling rate conditions were at 1 C (140 mA/g) for both the charge and the discharge steps. A constant voltage step to current limit C/20 was applied for the charge step.

FIG. 3A demonstrates improvement in the overall capacity of the battery including cathodes formed from active materials synthesized using a process control agent (test battery) as compared to the control battery. The test battery demonstrates a higher capacity throughout the cycling, and in particular at higher cycles. That is, the capacity plots of the test battery and control battery take on different trajectories around about cycle 60, even account for the initial positive offset in capacity shown by the test battery.

Further, FIG. 3A also demonstrates increased stability at high cycle numbers in the test battery as compared to the control battery. Beginning around cycle 170, the capacity measured for the control battery shows substantial variation, which is indicative of instability in the battery. In contrast, the test battery begins to show some variation in capacity measurement around cycle 190. By cycle 200, the variation in the capacity measured for the control battery is substantially greater than that of the test battery.

FIG. 3B demonstrates improvement in the capacity retention of the battery including cathodes formed from active materials synthesized using a process control agent (test battery) as compared to the control battery. As seen in FIG. 3B, the capacity retention of the control battery crosses the 90% level at around cycle 110, while the capacity retention of the control battery crosses the 90% level at around cycle 150. The test demonstrates a greater than 36% percent in cycle life as compared to the control battery, where cycle life refers to the ability of the battery to retain capacity at increasing cycles. Notably, this cycle life improvement occurs at relatively high temperature, which is a challenging environment for high voltage spinel active materials.

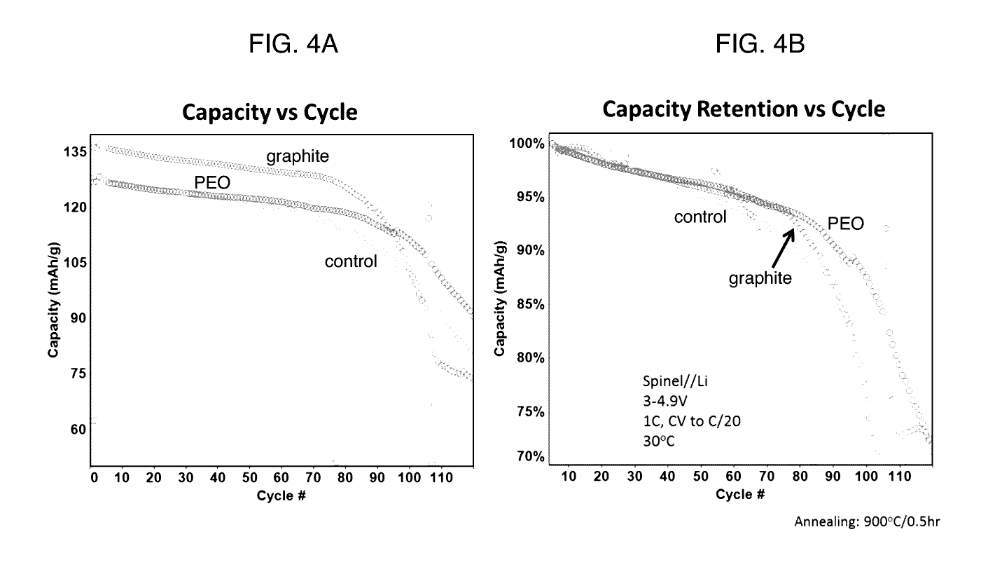

FIGS. 4A and 4B illustrate the results of electrochemical testing of batteries formed using various embodiments of the invention as compared to a control material. LMNO active materials were synthesized using various process control agents, including graphite, and poly(ethylene oxide), and are labeled with their process control agents in the figures. The LMNO active material synthesized without using a process control agent is labeled as “Control.” The battery cell was formed according to the methods disclosed herein, including the use of the lithium anode. After the formation cycles, the cell was cycled 120 times from about 3 V to about 4.9 V at room temperature. The cycling rate conditions were at 1 C (140 mA/g) for both the charge and the discharge steps. A constant voltage step to current limit C/20 was applied for the charge step.

Improvements have been demonstrated for process control agents including both graphite and poly(ethylene oxide). Improvement on both capacity and capacity retention are shown for graphite in FIG. 4A and FIG. 4B, respectively. The process control agent poly(ethylene oxide) provides similar capacity but improved capacity retention after about 70 cycles. More improvement for the electrochemical performance of active materials synthesized with these process control agents can be expected with further optimization.

The embodiments disclosed herein provide improvements in the electrochemical performance of active materials, and in particular spinel active materials. The improvement in capacity retention for these materials is significant, since diminished capacity retention is one of the biggest challenges to commercializing high voltage spinel active materials.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

1. A method for producing an active material for use in a lithium ion battery, comprising:
providing a lithium precursor, a transition metal precursor, and a process control agent;
milling the lithium precursor, the transition metal precursor, and the process control agent to form a milled powder; and
heating the milled powder for a time and temperature to form the active material.

2. The method of claim 1 wherein the process control agent comprises a carbon source.

3. The method of claim 2 wherein the carbon source comprises carbon black.

4. The method of claim 2 wherein the carbon source comprises graphite.

5. The method of claim 2 wherein the carbon source comprises an ethylene oxide polymer.

6. The method of claim 2 wherein the carbon source comprises poly(ethylene oxide).

7. The method of claim 1 wherein the heating is performed for a time less than 12 hours.

8. The method of claim 1 wherein the heating is performed for a time less than 1 hour.

9. The method of claim 1 wherein the heating is performed for a time of about 0.5 hour.

10. The method of claim 1 wherein the heating is performed at a temperature of at least 500 degrees Celsius.

11. The method of claim 1 wherein the heating is performed at a temperature of at least 700 degrees Celsius.

12. The method of claim 1 wherein the heating is performed at a temperature of at least 900 degrees Celsius.

13. The method of claim 1 wherein the milled powder contains unreacted process control agent.

14. The method of claim 13 wherein the heating consumes substantially all of the unreacted process control agent.

15. The method of claim 1 wherein the transition metal precursor comprises manganese.

16. The method of claim 1 further comprising an additional transition metal precursor.

17. The method of claim 16 wherein the additional transition metal precursor comprises nickel.

18. The method of claim 17 wherein the active material comprises LiMn_{1.5}Ni_{0.5}O₄.
